(19) United States
(12) Patent Application Publication
(10) Pub. No.: US 2004/0042697 A1
(43) Pub. Date: Mar. 4, 2004

(54) System of sliding surfaces comprising one carbon-based sliding element

(76) Inventors: Mathias Woydt, Berlin (DE); Jens Kleemann, Berlin (DE)

Correspondence Address: WILLIAM COLLARD, COLLARD & ROE, P.C., 1077 NORTHERN BOULEVARD, ROSLYN, NY, 11576, US

(21) Appl. No.: 10/380,760

(22) PCT Filed: May 29, 2002
(86) PCT No.: PCT/DE02/01969

(30) Foreign Application Priority Data
Jul. 18, 2001 (DE) 10135477.0

(51) Int. Cl. F16C 33/02

(52) U.S. Cl. 384/278; 384/905

(57) ABSTRACT

The invention relates to pairs of sliding elements having one carbon-based sliding element.

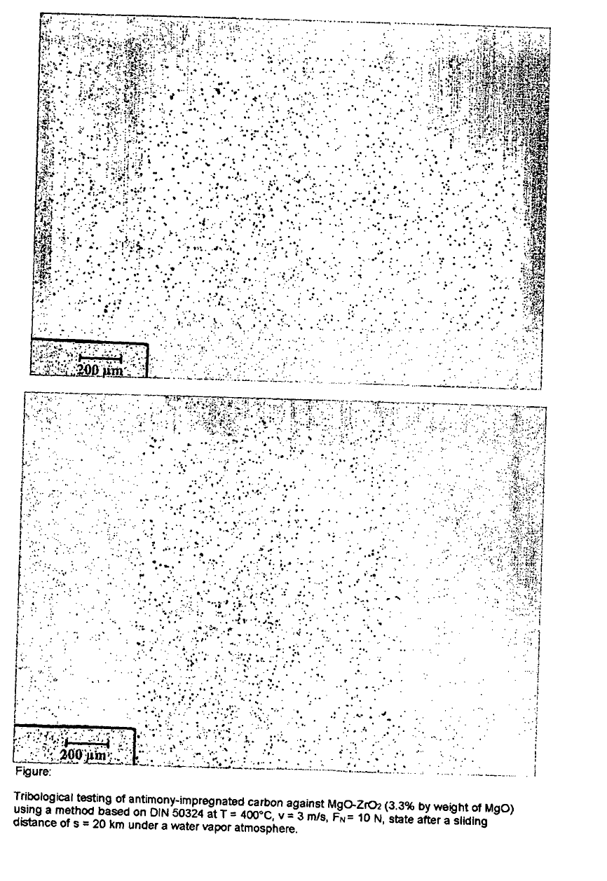

It is an object of the invention to provide pairs of sliding elements in which the first sliding element is based on carbon and no transfer layer of carbon has been formed or is present on the second sliding element, even in the run-in state. Such pairs of sliding elements should slide with a little wear even under an atmosphere of water vapor at high pressures and high temperature or on exposure to water.

According to the invention, this is achieved by pairs of sliding elements in which the second sliding element has a sliding surface which has a material composition and surface topography such that the formation of a transfer layer of carbon material of the first sliding element is prevented. The second sliding element comprises predominantly zirconium dioxide in the monoclinic, tetragonal or cubic crystallographic phase. It can advantageously further comprise up to 20% by weight of MgO and/or preferably 13-16% by weight of CeO₂.

The invention relates to pairs of sliding elements having one carbon-based sliding element as set forth in claim 1.

Pairs of sliding elements having a first sliding element based on carbon and a second sliding element which preferably has the thermal expansion behavior of carbon but whose sliding surface is formed by a different material, preferably a carbon, compared to the first sliding element are already generally known. Such pairings comprise, according to DIN 50320, a first sliding element having a 100% engagement ratio (base body) and a second sliding element having a less than 100% engagement ratio (counterbody).

The ability of such pairings to run dry is achieved by formation of a transfer film of the base body on the counterbody. Polymeric materials, extrinsic and intrinsic solid lubricants and soft metals, e.g. In, Pb, Au, Ag, Sn, are suitable for this purpose.

In the case of the first sliding element, various graphite shapes make it possible to obtain transfer film lubrication. It is possible to use mesophases of pitches derived from petroleum or coal, graphitized carbon, hard charcoals, electrographites, semicoke or mesophase powders having self-sintering properties or synthetic carbon.

According to prevailing opinion, sliding of a sliding partner comprising carbon on the other sliding partner of a pair of sliding elements forms a carbon layer on the surface by means of adhesion or affinity or by means of rubbing on to or into. In the run-in state of the pair of sliding elements, carbon effectively slides on carbon. The above-described pair of sliding elements are also suitable for machine parts which are exposed to water vapor at a high pressure and temperature level, preferably for piston/cylinder assemblies of steam engines, when antimony-impregnated carbons are used.

It has been found that the tribological properties and the life of pairs of sliding elements having one carbon-based sliding element can be improved when the formation of a transfer film of carbon on the other sliding element does not occur.

Accordingly, it is an object of the invention to provide pairs of sliding elements in which the first sliding element is based on carbon and no transfer layer of carbon has been formed or is present on the second sliding element, even in the run-in state. Such pairs of sliding elements should slide with a little wear even under an atmosphere of water vapor at high pressures and high temperature or on exposure to water.

According to the invention, this object is achieved by pairs of sliding elements in which the second sliding element has a sliding surface which has a material composition and surface topography such that the formation of a transfer layer of carbon material of the first sliding element is prevented. Adhesion or affinity between the sliding layers should be suppressed, so that no transfer layer can form when they slide against one another. Rubbing on and rubbing in of carbon is virtually completely prevented. On this subject, reference may be made to the figure indicating the experimental conditions and showing the materials used for the sliding elements.

Pairs of sliding elements according to the invention and their specific compositions, by means of which the above-described properties can be achieved, are described below.

According to the invention, the second sliding element comprises predominantly zirconium dioxide in the monoclinic, tetragonal or cubic crystallographic phase. It can advantageously further comprise up to 20% by weight of MgO and/or preferably 13-16% by weight of CeO₂.

The first sliding element comprising carbon advantageously comprises materials from the group consisting of mesophases comprising pitches derived from petroleum or coal, graphitized carbon, hard charcoals, electrographites, semicoke and mesophase powders having self-sintering properties and synthetic carbons.

The appended figure shows a highly magnified photograph of a pair of sliding elements according to the invention with a polished zirconiuum dioxide surface MgO—ZrO₂ on the second sliding element after dry running against a first sliding element comprising carbon. No graphitized carbon areas in the form of deposits which would be effective as sliding layers are formed. This indicates very low-wear sliding behavior in which the first sliding element comprising carbon loses virtually none of its material and experiences virtually no shape changes.

Among all material pairings tested, MgO—ZrO₂ occupies a special position in the presence of water vapor in combination with a sliding partner comprising carbon with antimony impregnation. An extremely low wear coefficient of Kv^{0.20.00m}=4.0×10⁻⁸ mm³/Nm with a friction number of only 0.008 at T=400° C. and 3 m/s at pressures per unit area of 1-100 MPa/mm² was obtained. These values could be confirmed in repeat experiments. They are typical of liquid-lubricated tribological systems in the friction state of mixed and limiting friction.

Scanning electron micrographs showed that virtually no visible carbon transfer layer was formed. Further surface-analytical techniques (microlaser Raman spectroscopy, small sport ESCA, Fourier transform infrared spectroscopy, X-ray defraction) indicated that no graphitized carbon particles or films adhered to a sufficiently smooth zirconium oxide surface. In the presence of water vapor, zirconium hydroxide Zr[OH]₄ (CAS:14475-63-9) is formed on the zirconium oxide surface. The sliding element comprising carbon in this case slides on a tribochemically formed layer of zirconium hydroxide, which is insoluble in water. Dehydration of such layers begins at about 600° C. in air.

According to the invention, a surface having such properties is formed by a sliding layer of any mixture of the material system antimony-antimony oxide-zirconium hydroxide.

To improve the adhesion of the surface layer, an intermediate layer of zirconium oxide or aluminum oxide is advantageously present under the sliding layer.

In the case of pairs of sliding elements according to the invention, running-in becomes unnecessary, i.e. proper running behavior does not require a transfer layer formed by wear during running in to be formed first between the sliding surfaces.

When a first sliding element composed of carbon impregnated with 40% by weight of antimony is used, an antimony oxide layer which has good frictional and wear behavior can be formed on the above-described surface of zirconium oxide of the second sliding element. As a consequence, the graphitized carbon surface of the first sliding element slides only on the antimony oxide layer formed.

When graphitized carbon impregnated with antimony is used for the first sliding element, a surface layer of zirconium hydroxide formed on the second sliding element in the presence of water vapor provides the better conditions for the attachment of antimony oxide via its OH groups. The result is sliding with very low wear of the graphitized carbon on a tribochemically formed layer of zirconium hydroxide or on a layer of antimony oxide formed by tribooxidation.

The second sliding element can advantageously comprise aluminum oxide having an Al₂O₃ content of at least 80% to which the surface of zirconium oxide is applied. A surface comprising a mixture of aluminum oxide and zirconium dioxide can likewise be used.

In this embodiment, a high strength of the base body and the physically virtually identical behavior of base body and surface layer of zirconium oxide are obtained.

The second sliding element is advantageously produced as a monolith, with its coating or coatings being produced by thermal spraying or physical vapor deposition.

The surfaces of the second sliding element advantageously have a zirconium hydroxide layer having a thickness of less than 1000 nm, but preferably in the range 10 nm<d<50 nm.

It is advantageous for the sliding behavior for the surfaces of the second sliding element to have radii of curvature of the microcontacts in the order of 5 μm<R<10 μm.

It can also be advantageous to impregnate the surfaces or the material of the first sliding element comprising carbon with up to 30% by weight of zirconium hydroxide.

1. A pair of sliding elements having one carbon-based sliding element and a further second sliding element which has thermal expansion behavior similar to carbon but has a different material composition, characterized in that the second sliding element has a sliding surface of a material which, on engagement, prevents the formation of a transfer layer based on carbon.

2. A pair of sliding elements as claimed in claim 1, characterized in that the second sliding element comprises predominantly zirconium dioxide in the monoclinic, tetragonal or cubic crystallographic phase.

3. A pair of sliding elements as claimed in claim 1 or 2, characterized in that the second sliding element comprising predominantly zirconium dioxide contains up to 20% by weight of MgO and/or 13-16% by weight of CeO₂.

4. A pair of sliding elements as claimed in claim 1, characterized in that the second sliding element has a sliding surface which comprises a layer of a mixture selected from the material system antimony-antimony oxide-zirconium hydroxide and engages with the carbon-based sliding element.

5. A pair of sliding elements as claimed in any of claims 1 to 4, characterized in that the second sliding element has an intermediate layer which serves to bond the layer which forms the sliding surface.

6. A pair of sliding elements as claimed in claim 5, characterized in that the intermediate layer comprises zirconium oxide or aluminum oxide.

7. A pair of sliding elements as claimed in claim 4, characterized in that the second sliding element comprises aluminum oxide having an A.₂O₃ content of at least 80% or a mixture of aluminum oxide with zirconium dioxide.

8. A pair of sliding elements as claimed in one or more of the preceding claims, characterized in that the first sliding element comprising carbon comprises carbon selected from the group consisting of mesophases comprising pitches derived from petroleum or coal, graphitized carbon, hard charcoals, electrographites, semicoke and mesophase powders having self-sintering properties and synthetic carbons.

9. A pair of sliding elements as claimed in claim 1 and any of claims 4 to 7, characterized in that the second sliding element is produced as a monolith and its coating or coatings are produced by thermal spraying or physical vapor deposition.

10. A pair of sliding elements as claimed in one or more of the preceding claims, characterized in that the first sliding element comprising carbon has an intermediate layer of zirconium oxide or aluminum oxide located under the sliding surface.

11. A pair of sliding elements as claimed in one or more of the preceding claims, characterized in that the surfaces of the second sliding element have radii of curvature of the microcontacts in the order of 5 μm<R<10 μm.

12. A pair of sliding elements as claimed in one or more of the preceding claims, characterized in that the surface of the second sliding element is coated with zirconium hydroxide in a thickness of up to 1000 nm, but preferably in the range 10 nm<d<50 nm.

13. A pair of sliding elements as claimed in one or more of the preceding claims, characterized in that the surfaces or the material of the first sliding element are/is impregnated with up to 30% by weight of zirconium hydroxide.
